(19) United States
(12) Patent Application Publication
(10) Pub. No.: US 2026/0350460 A1
(43) Pub. Date: Nov. 5, 2026

(54) CONTEXT-AWARE APPAREL SELECTION USING MACHINE LEARNING MODELS

(71) Applicant: Motorola Mobility LLC, Chicago, IL (US)

(72) Inventors: Amit Kumar Agrawal, Bangalore (IN); Krishnan Raghavan, Bangalore (IN); Nakul Patel, Bangalore (IN)

(73) Assignee: Motorola Mobility LLC, Chicago, IL (US)

(21) Appl. No.: 19/194,659

(22) Filed: Apr. 30, 2025

(51) Int. Cl. G06N 20/00

(52) U.S. Cl. CPC G06N 20/00

(57) ABSTRACT

In aspects of context-aware apparel selection using machine learning (ML) models, a mobile device extracts event data identifying an event to be attended by a user of the mobile device. To extract the event data, the mobile device uses an ML model to scan content on the mobile device and detect indicators of the event within the scanned content. The mobile device determines, using the ML model and based on the event data, event context data associated with the event. The mobile device analyzes, using the ML model, a digital wardrobe database of digital representations of apparel items belonging to the user and item context data associated with the digital representations of the apparel items. The mobile device outputs a notification based on an overlap between the event context data and item context data associated with at least one digital representation of an apparel item in the digital wardrobe database.

### BACKGROUND

Mobile devices, such as tablet devices, smartphones, and the like, are capable of performing a multitude of tasks in a wide range of environments. These devices have evolved to offer various functionalities beyond traditional communication, such as managing personal information and scheduling events. Additionally, mobile devices often include high-quality cameras for capturing memories, documenting information, or interacting with digital services. As many users rely on mobile devices to manage their daily lives, there is growing interest in leveraging the capabilities of these devices to provide more personalized and context-aware experiences. However, the integration of various data sources and the ability to provide relevant and timely services remain areas of ongoing development.

### BRIEF DESCRIPTION OF THE DRAWINGS

Implementations of the techniques for context-aware apparel selection using machine learning (ML) models are described with reference to the following Figures. The same numbers may be used throughout to reference like features and components shown in the Figures.

FIG. 1 illustrates an example communication system for context-aware apparel selection using ML models in accordance with one or more implementations as described herein.

FIG. 2 further illustrates an example of context-aware apparel selection using ML models in accordance with one or more implementations as described herein.

FIG. 3 illustrates an example of a graphical user interface (GUI) for context-aware apparel selection using ML models in accordance with one or more implementations as described herein.

FIGS. 4-7 illustrate example methods for context-aware apparel selection using ML models in accordance with one or more implementations of the techniques described herein.

FIG. 8 illustrates various components of an example device that may be used to implement the techniques for context-aware apparel selection using ML models as described herein.

### DETAILED DESCRIPTION

Implementations of the techniques for context-aware apparel selection using ML models may be implemented as described herein. A mobile device, such as any type of a wireless device, media device, mobile phone, flip phone, client device, tablet, computing, communication, entertainment, gaming, media playback, and/or any other type of computing and/or electronic device, or a system of any combination of such devices, may be configured to perform techniques for context-aware apparel selection using ML models as described herein. For example, a mobile device implements an outfit detection module that analyzes event data, user wardrobe information, and contextual factors to detect and notify a user of conflicts between aspects of an event and apparel to be worn by the user. In some cases, the outfit detection module can select alternative, contextually-appropriate apparel items to display to the user. In variations, the outfit detection module receives user input via a user interface of the mobile device that triggers or initiates the detection process for an upcoming or ongoing event. The mobile device analyzes available data and outputs alert notifications in real-time or near real-time. In one or more implementations, a server device includes an outfit detection manager, which can be used to implement aspects of the techniques described herein. The outfit detection module and/or the outfit detection manager implement or are implemented by one or more ML models or algorithms (e.g., neural network(s), artificial intelligence (AI) algorithms).

Conventional techniques for digital item selection often rely on manual (e.g., user-driven or user-initiated) processes or simplistic recommendation systems that fail to adequately consider the comprehensive set of circumstances, factors, and conditions associated with available items, including but not limited to historical usage, environmental considerations, social implications, and future applications. For example, existing selection systems implement rudimentary classification algorithms and/or models that lack the capability to perform multi-dimensional context analysis. Without effective correlation between item metadata and appropriate contexts, these systems output selections that are inaccurate, inappropriate, irrelevant, and/or repetitive. In the domain of apparel selection for an event, users relying on such systems may suffer social discomfort or embarrassment due to unsuitable attire for the event or unintended outfit duplication among event attendees.

Additionally, conventional selection techniques suffer from suboptimal utilization of computational resources. For instance, existing selection systems operate with fragmented data architectures, creating inefficient data processing pipelines that are unable to integrate information from diverse sources such as device applications, media storage systems, live camera feeds (e.g., livestreams), and social networking platforms. Further, conventional methods are incapable of efficiently storing, processing, and correlating large volumes of heterogeneous data from such sources. This architectural fragmentation leads to significant computational overhead when attempting to establish relational connections between apparel metadata and event parameters. The absence of unified data processing frameworks and efficient ML models for contextual analysis forces systems to rely on resource-intensive manual search operations across disparate databases, resulting in high latency and processing inefficiencies. Thus, a technical challenge lies in developing systems that can efficiently process and correlate large volumes of heterogeneous data in real-time, while implementing adaptive learning mechanisms that continuously refine selection algorithms based on usage patterns and feedback signals.

The present disclosure addresses the aforementioned technical limitations through an integrated architecture that leverages ML models to process and store contextual data and generate relevant selections from distributed content repositories. Aspects of the described techniques implement always-on sensing capabilities that enable a mobile device to continuously gather and analyze contextual information about a user's environment and activities. The mobile device may collect data from various sources, including the device itself, connected services, other user devices, and relevant individuals (e.g., via social media accounts, connected devices, and the like). By leveraging ML algorithms to process this diverse array of data, the mobile device can develop a comprehensive understanding of the user's context at any given moment. Additionally, the mobile device may store the collected contextual data in a local database, allowing it to refer back to historical information, learn from past patterns, and analyze trends over time. This context-aware system enables the mobile device to predict future events and scenarios, allowing it to proactively assist a user in various ways. For example, the mobile device may analyze weather forecasts in conjunction with the user's calendar and travel patterns to anticipate potential delays. Based on the analysis, the mobile device may automatically adjust the user's morning alarm to an earlier time, ensuring they have sufficient time to prepare and commute despite adverse weather conditions.

As described herein, such predictive capabilities can be implemented in numerous scenarios, such as suggesting appropriate attire based on anticipated events and social interactions. For example, the mobile device can utilize always-on sensing and data collection to maintain (e.g., manage, generate, update) a wardrobe database that includes digital representations of apparel items owned by the user. The wardrobe database includes information about the apparel items, such as types, attributes (e.g., characteristics, traits), associated events or individuals, usage history, and so forth. The mobile device may continuously scan digital content of the mobile device to detect apparel items and collect related data to store in the wardrobe database.

When monitoring digital content in this manner, the mobile device can detect upcoming or ongoing (e.g., current) events to be attended by the user. The mobile device implements an outfit detection module that leverages machine learning to provide contextually-aware apparel selection for the event(s). For example, using an ML model, the outfit detection module extracts and processes event data to determine or infer attendees of an upcoming event. The outfit detection module analyzes information from the wardrobe database to detect if any apparel items were previously worn by the user in the presence of these attendees, and can alert the user if this is the case. As another example, the outfit detection module can detect an ongoing (e.g., in-progress) event that the user is to attend, and may identify live camera feeds or streams, social media posts, and other real-time digital content related to the event. The outfit detection module implements the ML model to analyze apparel items being worn by attendees at the event, e.g., as shown in the digital content. The outfit detection module can alert the user if apparel items appearing in the digital content are the same as or substantively similar to apparel items in the user's wardrobe, enabling the user to avoid accidentally matching outfits with another attendee. In implementations, the outfit detection module selects alternative outfits for display to the user, e.g., based on contextual information associated with the event.

The techniques described herein support improved efficiency and accuracy in digital content management and context-aware selection processes. By implementing a unified data processing framework and efficient ML models for contextual analysis, the mobile device can collect, analyze, and integrate data from multiple sources, enabling efficient processing and correlation of large volumes of heterogeneous data in real-time and overcoming the limitations of fragmented data architectures and simplistic selection systems. The described techniques utilize ML models capable of analyzing complex contextual information and determining intuitive mappings between apparel items and events, providing increased computational efficiency and improved selection relevance compared to existing solutions. Additionally, the described techniques support continuous refinement of apparel selection algorithms based on usage patterns and feedback signals, providing adaptive learning mechanisms that improve over time. This comprehensive approach not only enhances the user experience by reducing the likelihood of social discomfort or embarrassment due to unsuitable attire or unintended outfit duplication, but also optimizes computational resource utilization by eliminating inefficient data processing pipelines and resource-intensive manual search operations across disparate data sources.

While features and concepts of the described techniques for context-aware apparel selection using ML models are implemented in any number of different devices, systems, environments, and/or configurations, implementations of the techniques for context-aware apparel selection using ML models are described in the context of the following example devices, systems, and methods.

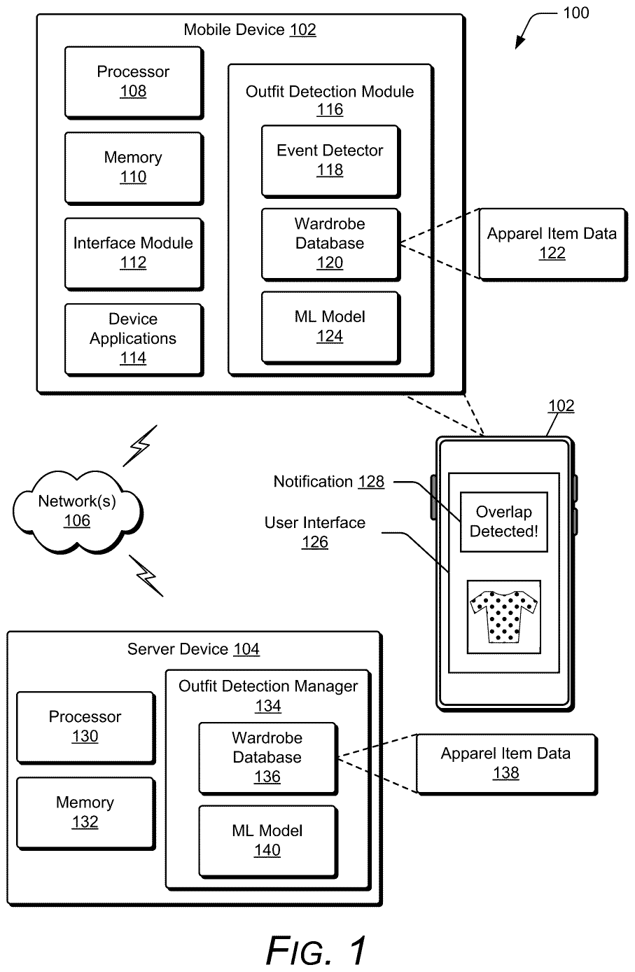

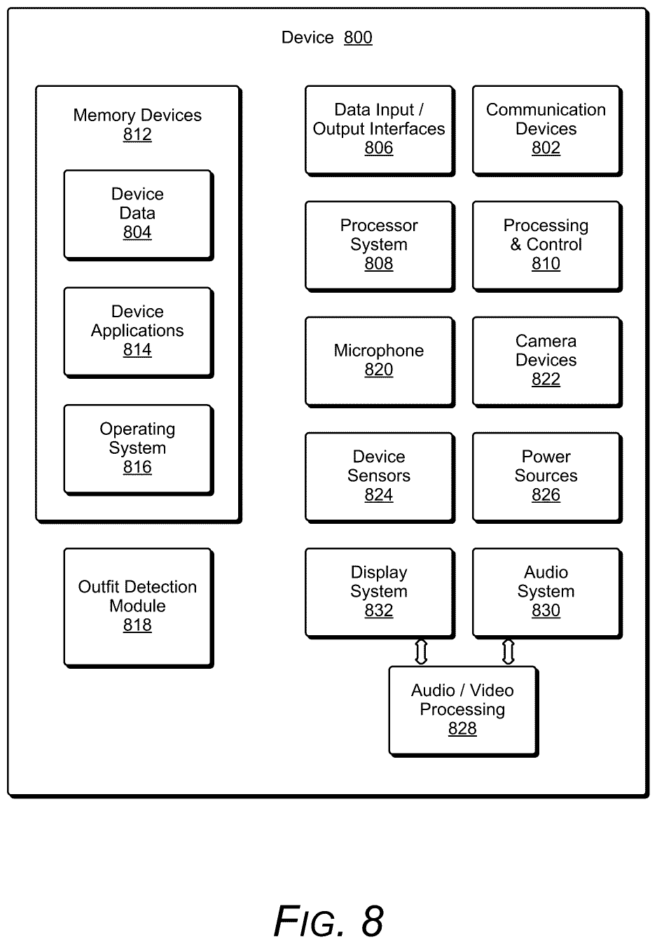

FIG. 1 illustrates an example communication system 100 for context-aware apparel selection using ML models as described herein. The communication system 100 includes a mobile device 102, a server device 104, and a network 106. Examples of the mobile device 102 include any type of wireless device, mobile device, smartphone, tablet, computing device, communication device, or other type of portable electronic device. The mobile device 102 can be implemented with various components, such as a processor system and memory, as well as any number and combination of different components as further described with reference to the example device shown in FIG. 8. In implementations, the mobile device 102 includes various capabilities for wireless communication with other devices. For example, the mobile device 102 can include WiFi, cellular, Bluetooth, Ultra Wideband (UWB), near field communication (NFC), or other wireless communication interfaces. Similarly, the server device 104 can be implemented with various components, such as a processor system and memory, as well as any number and combination of different components as further described with reference to the example device shown in FIG. 8.

In some implementations, the devices, applications, modules, and services described herein communicate via the network 106, such as for data communication between the mobile device 102 and the server device 104. The network 106 can include wired and/or wireless networks implemented using any type of network topology and/or communication protocol. The network 106 may represent or include a combination of two or more networks, including IP-based networks, cellular networks, and/or the Internet. The network 106 can also include mobile operator networks managed by mobile network operators and/or other network operators, such as communication service providers, mobile phone providers, and/or Internet service providers.

The mobile device 102 includes various functionality that enables the device to implement different aspects of context-aware apparel selection using ML models, as described herein. The mobile device 102 includes components, including a processor 108, a memory 110, and an interface module 112. The processor 108 and memory 110 provide data processing capabilities and data storage for the mobile device 102. In one or more examples, the interface module 112 represents functionality enabling the mobile device 102 to interconnect and interface with other devices and/or networks, such as the server device 104 via the network 106. For example, the interface module 112 enables wireless connectivity between the mobile device 102 and the server device 104 through cellular networks, Wi-Fi, Bluetooth, or other communication protocols. This connectivity allows the mobile device 102 to transmit event data to the server device 104 and receive indications (e.g., apparel item indications, alert indications) in return. The mobile device 102 can include and implement various device applications 114, such as calendar applications, messaging applications, web browser applications, email applications, photo/video applications, and/or social media applications, among other examples.

In the example communication system 100, the mobile device 102 implements an outfit detection module 116 (e.g., as a device application). The outfit detection module 116 includes an event detector 118, a wardrobe database 120 storing apparel item data 122, and an ML model 124 for analyzing data, detecting overlaps, and generating recommendations. As shown in this example, the outfit detection module 116 represents functionality (e.g., logic, software, and/or hardware) enabling aspects of the described techniques for context-aware apparel selection using ML models. The outfit detection module 116 can be implemented as computer instructions stored on computer-readable storage media and can be executed by a processor system of the mobile device 102. Alternatively, or in addition, the outfit detection module 116 can be implemented at least partially in hardware of the device.

In one or more implementations, the outfit detection module 116 includes independent processing, memory, and/or logic components functioning as a computing and/or electronic device integrated with the mobile device 102. Alternatively, or in addition, the outfit detection module 116 can be implemented in software, in hardware, or as a combination of software and hardware components. In this example, the outfit detection module 116 is implemented as a software application or module, such as executable software instructions (e.g., computer-executable instructions) that are executable with a processor system of the mobile device 102 to implement the techniques and features described herein. As a software application or module, the outfit detection module 116 can be stored on computer-readable storage memory (e.g., memory of a device), or in any other suitable memory device or electronic data storage implemented with the controller. Alternatively or in addition, the outfit detection module 116 is implemented in firmware and/or at least partially in computer hardware. For example, at least part of the outfit detection module 116 is executable by a computer processor, and/or at least part of the content manager is implemented in logic circuitry.

The mobile device 102 further includes a user interface 126 for display to a user, such as via a display screen of the mobile device 102. For example, the outfit detection module 116 can generate notifications 128 to be displayed via the user interface 126 to indicate outfit overlap alerts and selected apparel items to the user. In some examples, the user interface 126 includes or is an example of a graphical user interface (GUI) associated with the outfit detection module 116 and/or one or more device applications 114 to facilitate user interactions with digital content. A user may input information via interactable elements of the GUI (e.g., fill in a text element, elect a selectable element, or the like). For example, the user interface 126 may include controls for capturing photos, creating calendar events, or composing messages. As another example, the user interface 126 may display prompts requesting user input, such as user input indicating an upcoming event or apparel item data 122.

The server device 104 includes various functionality that enables it to implement different aspects of context-aware apparel selection using ML models, as described herein. The server device 104 contains components such as a processor 130, memory 132, and an outfit detection manager 134. The outfit detection manager 134 includes a wardrobe database 136 storing apparel item data 138. The outfit detection manager 134 implements or is implemented by an ML model 140. The server device 104 can communicate with the mobile device 102 to receive event data, analyze contextual information, select appropriate apparel items, and provide indications of a selected apparel item back to the mobile device 102 for display to the user via the user interface 126.

In one or more implementations, the outfit detection module 116 implements or is implemented by the ML model 124. The ML model 124 may include or be an example of a neural network, one or more artificial intelligence (AI) algorithms, a convolutional neural network (CNN), and/or any other type of ML model. As used herein, the term “ML model” refers to a computer representation that is trainable based on inputs to approximate unknown functions. For example, an ML model can utilize algorithms to learn from, and make predictions on, inputs of known data (e.g., training and/or reference images) by analyzing the known data to learn to generate outputs. The ML model 124 may be trained on diverse datasets including various types of event data, user preferences, digital content attributes, apparel item attributes, and so forth. For instance, the ML model 124 may learn to associate apparel items with event types or recognize patterns in a user's past choices. The training process may involve supervised learning, where the ML model 124 is presented with labeled examples of events and corresponding appropriate apparel items. As the ML model 124 processes more data over time, it can adapt to individual user preferences and improve the accuracy of its recommendations.

In one or more implementations, and similar to the outfit detection module 116, the outfit detection manager 134 can implement or be implemented by an ML model 140 that can analyze event information and select an apparel item from a wardrobe database 136. The outfit detection manager 134 implemented as the ML model 140 may include AI, an ML model or algorithm, a CNN, and/or any other type of ML model.

The mobile device 102 and the server device 104 can process and analyze various types of digital content. As used herein, the term “digital content” refers to information or media that is created (e.g., generated), processed, stored, transmitted, or displayed in a digital format, such as by one or more device applications 114. Examples of digital content may include, but are not limited to, photos, videos, text messages, calendar entries, social media posts, documents, and audio recordings. Additionally, digital content can correspond to (e.g., indicate, denote, represent) real-world items. For example, the apparel item data 122 and 138 include digital representations of apparel items (e.g., clothing items, accessories, shoes, and so on) owned by a user. The term “digital representation” refers to a computer-readable format that captures and stores information about physical apparel items owned by a user. Digital representations may include various data formats such as images, textual descriptions, metadata, or structured data records that collectively describe the characteristics and attributes of apparel items. Examples of digital representations can include, but are not limited to, photographs of clothing items captured by the mobile device's camera, textual descriptions of apparel items entered by the user and/or generated by an ML model (e.g., the ML model 124, the ML model 140), digital receipts from online purchases, social media posts showing the user wearing specific items, or structured data entries in the wardrobe databases 120 and/or 136 containing information about color, style, brand, size, fabric, and usage history of apparel items. These digital representations enable the outfit detection module 116 (e.g., and the outfit detection manager 134, the ML model 124, and the ML model 140) to analyze and process information about the user's wardrobe without requiring direct access to physical apparel items.

The wardrobe database 120 and the wardrobe database 136 serve as comprehensive digital repositories for storing and organizing apparel item data 122 and apparel item data 138, respectively. These databases are designed to maintain a structured catalogue (e.g., index, directory, log) of the digital representations of apparel items, including corresponding item attributes, item context data, relevant event information (e.g., event data, event context data), among other examples. For example, the mobile device 102 implements the wardrobe database 120 to maintain the apparel item data 122 associated with the user. The wardrobe database 120 may represent one or more storage systems and/or storage devices capable of storing digital content items and associated metadata. Each entry in the wardrobe database 120 corresponds to a respective digital representation of an apparel item and may include metadata such as item type, attributes, origin information, and usage history, among other examples. Usage history may refer to information related to the user's interactions with apparel items and/or digital representations of apparel items, such as a quantity of instances in which the user wore an apparel item.

While the examples described below generally relate to the outfit detection module 116, ML model 124, wardrobe database 120, and apparel item data 122 at the mobile device 102, these examples and techniques may also be applicable to and implemented by the outfit detection manager 134, ML model 140, wardrobe database 136, and apparel item data 138 at the server device 104. That is, the techniques described herein may be implemented either locally at the mobile device 102 or implemented at the server device 104 based on communications with the mobile device 102, and the described techniques and examples should not be construed as limiting. For example, the event detector 118 may transmit, to the server device 104, an indication of an event detected at the mobile device 102 and/or information related to the event, such as attendees, detected apparel being worn at the event, and the like. The server device 104 may implement the ML model 140 to analyze the wardrobe database 136 according to the described techniques. The server device 104 may transmit, to the mobile device 102, an overlap alert, a selected apparel item, or both for display via the user interface 126. This distributed approach allows for flexibility in processing and storage, enabling the communication system 100 to leverage the computational resources of both the mobile device 102 and the server device 104.

The mobile device 102 may implement always-on sensing capabilities to continuously gather and analyze contextual information about a user's environment and activities. The mobile device 102 may collect data from various sources, including the device itself (e.g., model, color, location, orientation, surroundings, connectivity), connected services (e.g., time-critical events, future appointments, notifications, current location, user attention), other devices (e.g., connected devices, zone proximity, wireless signals, user interaction), and information related to friends and family (e.g., their devices, locations, and statuses). The mobile device 102 may implement the outfit detection module 116 and the ML model 124 to process the collected data to infer the user's context in real-time, e.g., by generating contextual information using the ML model 124. The mobile device 102 can store collected data and/or generated contextual data in the wardrobe database 120. Additionally, the mobile device 102 can utilize the wardrobe database 120 to refer back to historical information, learn from past patterns, and analyze trends over time to improve the accuracy and relevance of its recommendations.

In implementations, the wardrobe database 120 is manually compiled, such as by direct user input via the user interface 126. For example, the outfit detection module 116 at the mobile device 102 may generate the user interface 126 to enable the user to input apparel item data 122 for an apparel item, such as photos and/or videos, an item type, attributes, origin information, significance or sentimental value, associated occasion/event information (e.g., a sports event associated with a team jersey, appropriate events to which an apparel item can be worn, etc.), associated individuals, and usage history (e.g., events to which the apparel item has been worn, attendees in front of whom the apparel item has been worn, frequency of wear, etc.). Using the user input, the outfit detection module 116 generates and stores a respective database entry for each item. A database entry includes or is an example of a digital representation of an apparel item. The outfit detection module 116 populates each database entry with corresponding information (e.g., metadata, context data) about the apparel item.

Additionally, or alternatively, the wardrobe database 120 may be automatically generated by the outfit detection module 116, e.g., without or in addition to user input. In such examples, the outfit detection module 116 scans (e.g., systematically examines, parses, crawls) digital content on the mobile device 102 to identify indicators of apparel items. The outfit detection module 116 may also integrate with other device applications 114 to identify apparel items and gather associated apparel item data 122. For example, the outfit detection module 116 may implement the ML model 124 to parse text-based content such as messages, emails, and social media posts to identify indicators (e.g., key words or phrases) of items, such as references to purchases, images of the user wearing apparel, and the like. The ML model 124 can also utilize computer vision algorithms (e.g., image recognition, object detection) to detect and classify indicators of apparel items in photos and videos, as well as optical character recognition (OCR) to extract text information like brand names or product descriptions.

Based on the indicators, the ML model 124 may identify an apparel item and associated apparel item data 122. As described herein, apparel item data 122 refers to information that directly describes an apparel item, such as an item type, attribute (e.g., color, style, size, etc.), dimension(s), source information (e.g., when and where an apparel item was acquired or used), and so forth. The ML model 124 may be trained (e.g., pre-trained) to associate the indicators with apparel items and to extract relevant apparel item data 122, based on which the outfit detection module 116 generates, populates, and stores database entries. For instance, the ML model 124 may extract, from a user-captured photo of an apparel item, metadata such as the date, time, location, and any tags or descriptions associated with the image. The ML model 124 may store the metadata in a database entry of the wardrobe database 120 corresponding to the apparel item.

Additionally, the outfit detection module 116 implements the ML model 124 to determine or otherwise generate context data (e.g., item context data) associated with apparel items and may store the context data in the wardrobe database 120, e.g., as part of the apparel item data 122. As described herein, item context data refers to information providing context about an item's significance, usage, and relationships. For example, item context data can include, but is not limited to, usage information (e.g., instances of wear, time/date, recency of use, frequency of use, attendees of events to which the apparel item has been worn by the user), associated events (e.g., occasions, activities, attended events to which the user wore the item), relationships to other items or individuals, emotional significance or sentimental value, formality level, seasonal relevance, social contexts, user preferences, associated individuals or groups, and the like. While item data provides factual information about the digital content item itself, item context data offers insights into how, when, and why an item is significant or useful to the user.

For example, the outfit detection module 116 implements the ML model 124 to infer or otherwise derive item context data for an apparel item by analyzing patterns, user behavior, and relationships between the apparel item and other information (e.g., extracted information). The ML model 124 may apply natural language processing to understand item contexts and can infer or otherwise determine usage patterns indicative of how the user interacts with an apparel item. The outfit detection module 116 may implement the ML model 124 to extract and analyze information from social media posts, photo captions, and user-added tags to infer an item's sentimental value to the user, associated events or individuals, relationships with other items, and so forth. As a non-limiting example, the ML model 124 can analyze calendar entries for events associated with specific items (such as formal wear for a wedding).

The ML model 124 can utilize metadata associated with digital content, such as timestamps, geolocation data, and user-added tags, to infer information about when and where apparel items were acquired or used. Geolocation metadata from images or social media posts provides insights into where an apparel item was purchased or worn, indicating the item's suitability for different locations or climates. As another example, the ML model 124 can analyze the user's photos and photos shared in messaging applications to detect apparel previously worn at an event. The ML model 124 can cross-reference these images with a list of attendees of the event to track instances where the apparel item was worn in the presence of the attendees.

As the ML model 124 scans and analyzes digital content, it may populate and/or update the wardrobe database 120 with extracted and inferred information (e.g., apparel item data 122, item context data) such as item types, attributes, origins, relationships, and usage patterns, among other examples. The ML model 124 can assign tags to each digital representation of an apparel item based on the apparel item data 122 and item context data. For instance, the ML model 124 can assign tags such as “work,” “travel,” “casual,” “trip to Paris,” “quantity of instances worn,” “last wear date,” and the like. The tags can indicate contextual information for the apparel item. The ML model 124 correlates metadata from multiple sources to build a comprehensive understanding of an item's context. For instance, the ML model 124 may combine timestamp data from photos with calendar entries from the same date to associate items with specific events or occasions. The ML model 124 can refine and categorize this information, improving the accuracy and relevance of the apparel item data 122 stored in the wardrobe database 120 over time.

In the example communication system 100, the outfit detection module 116 implements the event detector 118 to identify an upcoming or ongoing event. The event detector 118 implements or is implemented by the ML model 124 to perform the techniques described herein. When an event is detected, the outfit detection module 116 may implement the ML model 124 to identify overlaps between data associated with the event and data associated with at least one digital representation of an apparel item (e.g., apparel item data 122, item context data). For example, the ML model 124 may detect an overlap between one or more attendees of the event (e.g., event data) and one or more attendees of an event to which an apparel item was previously worn (e.g., item context data for the apparel item). As another example, the ML model 124 may detect an overlap between an apparel item that the user has selected to wear for the event (e.g., item context data for the apparel item) and an apparel item being worn by a person in a livestream of the event (e.g., event context data). The outfit detection module 116 generates the notification 128 to indicate any detected overlaps to the user via the user interface 126.

An “event” as defined herein may be a planned or scheduled occurrence, activity, occasion, etc. that the user of the mobile device 102 intends to attend or participate in. Examples of events may include, but are not limited to, a social gathering, professional meeting, personal appointment, entertainment activity, or any other type of engagement. Events may be associated with attributes and context such as a time, date, duration, location, type of event, its purpose, attendees, dress code (e.g., formality level), and any associated activities or requirements. To detect an event, the event detector 118 may continuously monitor digital content of the mobile device 102 for event indicators (e.g., key words, phrases, images, or the like that refer to or otherwise indicate an event). For example, the event detector may scan digital content associated with the device applications 114 to identify event indicators, such as calendar entries, event invitations sent and received via messages or email, or location check-ins on social media.

Upon detection of an event, the outfit detection module 116 extracts event data based on the indicator(s). For example, the event detector 118 may detect an event from an entry in a calendar application. Based on (e.g., subsequent to) the detecting, the outfit detection module 116 may extract event data from the entry, such as a date, time, location, type of event (e.g., social gathering, professional meeting, personal appointment), and attendee(s). As another example, the ML model 124 may detect that an event is currently ongoing and may monitor real-time digital content, such as livestreams, messaging exchanges, feeds from other devices (e.g., smart glasses worn by the user), and the like.

The outfit detection module 116 implements the ML model 124 to parse and interpret the extracted event data and determine or otherwise generate event context data associated with the event, e.g., in a similar manner to determining item context data. For instance, the ML model 124 might recognize key words or phrases that indicate the formality level of the event, its purpose, attendees, or any particular requirements (e.g., dress code, admissions, etc.). Additionally, or alternatively, the ML model 124 may predict event context data based on historical information or trends. In implementations, the ML model 124 scans additional relevant digital content to determine the event context data, such as contact information or social media accounts associated with one or more attendees, historical event data associated with the user, and the like.

To detect outfit overlaps for the event, the ML model 124 analyzes the event context data and the item context data and searches the wardrobe database 120 for apparel items that might create “twinning” (e.g., unintended matching) or outfit repetition situations. For example, the ML model 124 can identify attendees of the event and search the wardrobe database 120 for digital representations of apparel items that have been worn in the presence of the same attendees. As another example, the ML model 124 can search and analyze the wardrobe database 120 for digital representations of apparel items worn to previous events having similar contexts to the present event. For instance, the event may be a board game night that takes place at a same location every other week. Based on this context, the ML model 124 can search for apparel items worn to similar events, events at the same location, or events having similar scheduling. If the event is ongoing, the ML model 124 can analyze live feeds, social media posts, or other digital content related to the event to identify apparel items currently being worn by attendees and extract attributes associated with these items to compare with the user's wardrobe. The ML model 124 can search the wardrobe database 120 for apparel items having the same or similar attributes.

Additionally, or alternatively, the ML model 124 can identify a user's selected outfit for the event and detect overlap between the selected outfit and the event context data. For example, the ML model 124 may monitor digital content, such as conversations and photos shared with friends, “selfies” captured by the mobile device 102 while the user is getting ready, or a live feed from another user device, such as smart glasses worn by the user, to detect the user's selected outfit. The ML model 124 identifies attributes of the selected outfit and compares the attributes with those of apparel items in an event live feed. In this example, the ML model 124 may utilize image recognition and object detection to identify outfit matches or near-matches between the user's outfit and the apparel items detected at the event.

When overlaps are identified, the outfit detection module 116 generates the notification 128 to alert the user via the user interface 126. The notification 128 may include or be an example of a pop-up alert, a banner, or an in-app message. The notification 128 indicates that an overlap is detected between item context data and event context data. The overlap may be, for example, between attendees of previous events to which the user has worn the apparel item (e.g., item context data) and attendees of the upcoming event (e.g., event context data). As another example, the overlap may be between item context data including aspects of previous instances in which an apparel item was worn (e.g., event types, locations, scheduling) and event context data that matches the previous instances. Additionally, or alternatively, the overlap may be between the user's selected outfit (e.g., item context data) and an apparel item detected in a live feed of the event (e.g., event context data).

In implementations, the notification 128 provides information about the detected event and the specific nature of the overlap, such as “You wore this outfit the last time you met with this client” or “Someone at the event is wearing a similar outfit based on the live feed.” In some examples, the outfit detection module 116 may select alternative outfits from the wardrobe database 120 for display to the user via the notification 128, e.g., based on contextual information associated with the event, to minimize the risk of accidental overlap. Here, the outfit detection module 116 selects alternative apparel items from the wardrobe database 120 that have few or no detected overlaps with the event context data.

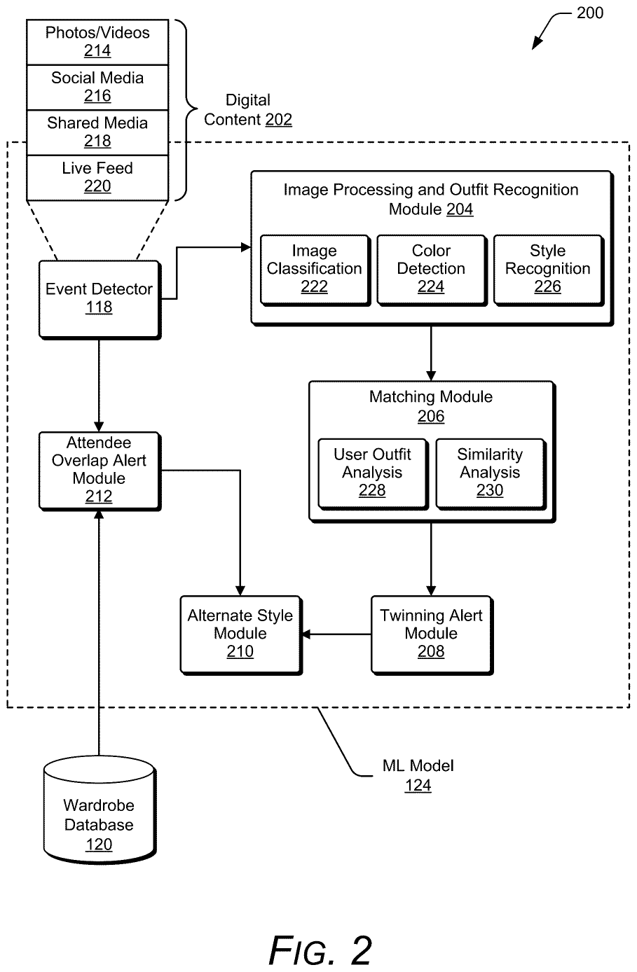

FIG. 2 illustrates an example 200 of context-aware apparel selection using ML models, as described herein. The example 200 may implement aspects of the communication system 100. For instance, the example 200 can be implemented by the outfit detection module 116 of the mobile device 102 as described with reference to FIG. 1. Additionally, the example 200 includes the wardrobe database 120 and the ML model 124 (e.g., as described with reference to FIG. 1), which are implemented to process digital content 202, detect events, infer context data, detect overlaps, and output alert notifications. The ML model 124 implements or is implemented by the event detector 118 (e.g., as described with reference to FIG. 1), an image processing and outfit recognition module 204, a matching module 206, a twinning alert module 208, an alternate style module 210, and an attendee overlap alert module 212.

The event detector 118 implements or is implemented by the ML model 124 to detect an event to be attended by the user of the mobile device 102. In implementations, the event is detected based on user input indicating an event, such as via a GUI or other interface of the mobile device 102. Additionally, or alternatively, the event detector 118 continuously monitors (e.g., scans) digital content 202 on the mobile device 102 for indicators of upcoming events. The digital content 202 can include, but is not limited to, photos/videos 214 (e.g., stored on the mobile device 102 or accessed through a device application, such as cloud storage, websites, social media platforms, etc.), social media 216 (e.g., digital content associated with social media platforms, such as posts, stories, profiles, etc.), shared media 218 (e.g., photos/videos shared to the mobile device 102), and a live feed 220. For example, from social media 216, the event detector 118 may detect event invitations, RSVPs, or posts mentioning upcoming gatherings with specific dates and attendees. When analyzing shared media 218, the event detector 118 can identify outfit photos sent between users with captions like “Wearing this outfit to tonight's party” or “What do you think of this dress for the wedding?”

A “live feed” refers to real-time or near-real-time digital content streams that provide current information about an event as it is happening. Examples of live feeds may include, but are not limited to, live video streams (e.g., from an event venue or an attendee), real-time social media updates from attendees, live photo sharing in messaging applications, or data streams from connected devices such as smart glasses or smartwatches worn by attendees and/or the user. These live feeds provide up-to-date information about the event, including visual data about what attendees are wearing, allowing the outfit detection module 116 to perform real-time analysis and provide timely notifications to the user about potential outfit overlaps.

In addition to detecting events, the ML model 124 may continuously or periodically scan (e.g., parse, analyze) the digital content 202 of the mobile device 102 to identify digital representations of apparel items and extract event data and item data. In some examples, the ML model 124 utilizes OCR to extract text information like brand names or product descriptions. The ML model 124 implements or is implemented by the image processing and outfit recognition module 204 and/or the matching module 206 to detect apparel items and corresponding attributes in the digital content 202. The image processing and outfit recognition module 204 includes components for image classification 222, color detection 224, and style recognition 226 that analyze visual content to identify apparel items. The image classification 222 component detects and categorizes apparel items within images or video frames, identifying item types such as shirts, dresses, or accessories. The color detection 224 component analyzes the color properties of detected apparel items, extracting information about primary and secondary colors, patterns, and color combinations. The style recognition 226 component identifies style attributes of apparel items, such as neckline types, sleeve lengths, or fabric textures.

The wardrobe database 120 stores extracted item data and event data from digital content 202. In implementations, when an indicator of an apparel item and/or event is detected, the ML model 124 classifies and organizes the corresponding extracted data for storage in the wardrobe database 120. For instance, when a new photo containing apparel is detected, the ML model 124 can automatically add the apparel items to the wardrobe database 120 with appropriate attributes derived from the context in which they appear. As a specific example, the ML model 124 may detect, in an email, an indicator in the form of a purchase receipt and may analyze the email to identify a sweater purchased by the user, as well as any associated attributes (e.g., type, color, size). The ML model 124 automatically updates the wardrobe database 120 with a database entry for the sweater and populates the entry with the attributes.

The ML model 124 processes the digital content 202 and extracted data to determine (e.g., generate, derive, infer) event context data and item context data. The ML model 124 may be pre-trained to recognize patterns and contextual cues associated with events and apparel items. For instance, the ML model 124 may associate event-related phrases like “wedding” with a high formality level, or “lunch” and a location of an office with a time duration of an hour. In some examples, the ML model 124 may also analyze historical user behavior patterns for similar events and items. The ML model 124 determines event context data for an event by analyzing collected event data, such as a location (e.g., a restaurant, an office, a concert venue), time information (e.g., evening, morning), attendees, and the like, and associating the event data with relevant contextual information, such as a formality level (e.g., casual, formal), a type (e.g., client meeting, wedding, lunch), attendee relationships (e.g., colleagues, friends, clients).

To determine item context data for a digital representation of an apparel item, the ML model 124 analyzes item data such as style, type, etc. and associates the item data with relevant contextual information, such as a purpose, usage history, relationships with other items, associated individuals, relevant events, and the like. For example, the ML model 124 can process and analyze item data stored in the wardrobe database 120 and/or extracted from digital content 202 to infer item context data. The ML model 124 may store the item context data in the wardrobe database 120, such as by populating a database entry associated with a digital representation of an apparel item with the item context data. Additionally, or alternatively, the ML model 124 may assign tags to one or more digital representations of apparel items within the wardrobe database 120. As an example, the ML model 124 may tag a digital representation of an apparel item with calendar data extracted from a calendar application, such as event information and attendee data.

Upon detection of an event by the event detector 118, the ML model 124 analyzes the digital content 202 and/or the wardrobe database 120 to detect overlap between event context data associated with the event and item context data associated with apparel items belonging to the user. An “overlap” as defined herein refers to a similarity or match between event data (including event context data) and apparel item data (including item context data). Overlaps can occur in various forms, including but not limited to: (1) an overlap between attendees of a present event and attendees of past events where the user wore an apparel item, (2) an overlap between attributes (e.g., color, style, pattern) of the user's selected outfit for an event and attributes of an outfit detected in a live feed of the event, and (3) an overlap between an event type of a present event and an event type to which the user previously wore an apparel item. For example, an overlap may be detected if the user plans to wear a red dress to an upcoming party, and the ML model 124 identifies that the user previously wore the same red dress to an event attended by some of the same people who will be at the upcoming party. Similarly, an overlap may occur if the user selects a blue striped shirt for a meeting, and the ML model 124 detects a similar blue striped shirt being worn by another attendee in a live video feed of the meeting.

To detect overlap, the ML model 124 examines the event context data and compares it with item context data in the wardrobe database 120. For example, the ML model 124 can cross-reference a list of attendees for the event (e.g., event context data) with historical data about past events associated with apparel items, such as attendee information (e.g., item context data). The ML model 124 identifies apparel items worn in the presence of attendees who will also be present at the upcoming event. This analysis helps prevent unintended outfit repetition in front of the same group of people. For example, for an event identified as “wedding,” the ML model 124 may search the wardrobe database 120 for digital representations of apparel items previously worn to weddings with the same attendees. For an event identified as “trip to the beach,” the ML model 124 can search for items tagged with “swimming,” “sun protection,” and analyze if they've been worn in the presence of the same individuals who will attend the beach trip.

If overlap exists between any attendees on the list and any attendees associated with apparel items in the wardrobe database 120, the ML model 124 can alert the user via an attendee overlap alert module 212, which generates a notification (e.g., an alert) to display via a user interface of the mobile device. The notification may indicate the apparel items associated with the attendees, enabling the user to avoid inadvertently repeating an outfit choice in front of the attendees. In implementations, the notification indicates additional information, such as “You wore this dress at last month's charity gala, which was also attended by John and Sarah, who will be at tonight's dinner party.”

In implementations, the ML model 124 detects an outfit selected by the user for the event. For example, the user may provide direct user input via the user interface, where the user indicates which apparel items they plan to wear to the event. Additionally, or alternatively, the ML model 124 can automatically detect the selected outfit via the digital content 202. For instance, the ML model 124 scans conversations and photos shared with friends, “selfies” captured by the mobile device 102 while the user is getting ready, or a live feed from another user device, such as smart glasses worn by the user. The ML model 124 analyzes this content to identify the user's selected apparel items for the event. The ML model 124 can detect overlap based on the user's selected outfit. For example, if the user plans to wear a blue blazer to a meeting, the ML model 124 checks if the same blazer was worn to previous events attended by any of the current meeting's participants.

In some examples, the ML model 124 implements the image processing and outfit recognition module 204 and/or the matching module 206 to detect overlap. For example, the ML model 124 can utilize the image processing and outfit recognition module 204 to analyze the digital content 202 to detect apparel items previously worn by the user to past events of a similar event type or including attendees who will also be attending the upcoming event. As another example, the image processing and outfit recognition module 204 can be implemented to detect the user's selected outfit in digital content 202. Additionally, or alternatively, if the event is ongoing (e.g., happening in real-time), the image processing and outfit recognition module 204 can analyze live feeds 220 to identify apparel items being worn at the event.

Based on apparel items detected by the image processing and outfit recognition module 204, the matching module 206 identifies overlaps through user outfit analysis 228 and similarity analysis 230. The user outfit analysis 228 identifies attributes of apparel items to be worn by the user (e.g., item context data), while the similarity analysis 230 compares these attributes to event context data, such as previous attendee information or attributes of apparel items detected in a live feed 220 of the event. When the user's selected outfit is detected, the matching module 206 can receive the outfit's attributes from the image processing and outfit recognition module 204 or, in some examples, from the wardrobe database 120. For instance, the user outfit analysis 228 can search the wardrobe database 120 for entries corresponding to apparel items of the user's selected outfit. If a match is found, the ML model 124 can skip the process of extracting apparel item data from the digital content 202 and instead extract relevant attributes from the wardrobe database 120. This approach improves efficiency by avoiding redundant processing of known outfits.

If no selected outfit is detected, the user outfit analysis 228 analyzes apparel item data for relevant apparel items (e.g., apparel items that the user may select for the event) in the wardrobe database 120. For example, the user outfit analysis 228 can search the wardrobe database 120 for apparel items associated with the event type and extracts corresponding attributes. In either case, the similarity analysis 230 compares attributes of the user's apparel (e.g., selected outfit or relevant apparel items) with event context data to detect an overlap. For example, the similarity analysis 230 compares attributes of apparel items detected in the digital content 202, including live feeds 220 and social media 216, with the attributes of the user's selected outfit or of apparel items in the wardrobe database 120. This comparison enables detection of “twinning” situations where the user's outfit might closely resemble that of another attendee at the event. The similarity analysis 230 may a degree of similarity based on the comparison. If the degree of similarity is above a threshold, the ML model 124 can alert the user via a twinning alert module 208.

The ML model 124 generates notifications via the twinning alert module 208 when the similarity analysis 230 indicates a high risk of outfit duplication or a significant similarity. For instance, if the matching module 206 identifies that another attendee is wearing a dress very similar to the user's chosen outfit in a live feed from the event venue, the twinning alert module 208 generates a notification (e.g., an alert). This notification might include details about the similarity, such as “Another guest is wearing a similar red dress with a V-neckline.” Thus, the user can select a different outfit for the event and avoid accidentally matching apparel with another attendee.

In some examples, when overlaps are detected, the alternate style module 210 provides alternative outfit suggestions. The alternate style module 210 does so by analyzing the wardrobe database 120 and selecting apparel items that have a lower risk of overlap with the event context data. In some examples, the image processing and outfit recognition module 204 and/or the matching module 206 may send information to the alternate style module 210, assisting in the selection of alternative outfit suggestions that minimize the risk of unintended matching while remaining appropriate for the event context. The alternate style module 210 may consider factors such as the event type, formality level, and past successful outfit choices for similar events. For instance, if the user's initial choice of a black suit for a business meeting is flagged for overlap, the alternate style module 210 might suggest a navy suit or a different combination of items that maintain the required level of formality while reducing the risk of matching with other attendees. As another example, if the ML model 124 identified apparel items as having been worn by the user in front of the attendees at a previous event, the alternate style module 210 can select apparel items lacking any association with the attendees. The alternate style module 210 can indicate the alternative outfit suggestions via an alert (e.g., generated by the attendee overlap alert module 212 or the twinning alert module 208) displayed to the user. In some examples, the alternate style module 210 may select multiple alternative apparel items for display, such as a subset of appropriate apparel items with minimal overlap risk (e.g., an apparel item and one or more accessories that haven't been worn in front of the same attendees).

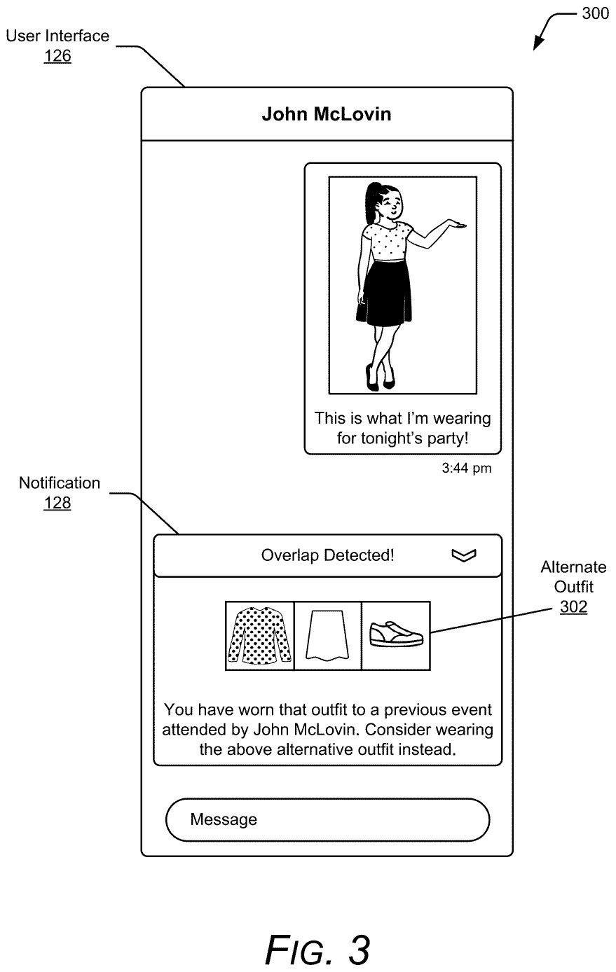

FIG. 3 illustrates an example GUI 300 for providing digital content recommendations in accordance with one or more implementations as described herein. The GUI 300 may implement or be implemented by aspects of the communication system 100. For example, the GUI 300 includes the user interface 126 and the notification 128 as described with reference to FIG. 1. The user interface 126 and the notification 128 may be implemented by an outfit detection module of a mobile device, such as the outfit detection module 116 and the mobile device 102, to display the notification 128 to the user. The GUI 300 serves as an interactive interface to present detected overlap information and offer a user options to address outfit duplications or similarities. This real-time feedback mechanism allows users to make informed decisions about their outfit choices before attending an event, thereby avoiding potentially awkward social situations.

The user interface 126 may include controls for selection or other interaction by the user. As illustrated, the user interface 126 displays a messaging application of the mobile device, in which the user has sent, to John McLovin, a photograph of an outfit planned for an upcoming party. The outfit detection module may implement an ML model (e.g., the ML model 124) to scan the content of the messaging application and detect an event and the user's selected outfit. For example, using natural language processing techniques, the ML model identifies indicators of potential events, such as mentions of dates and times, locations, or phrases like “tonight's party.” When such indicators are detected, the outfit detection module implements the ML model to extract relevant event data from the messages, such as a type of event (e.g., a party) and potential attendees (e.g., a recipient of the message, John).

The ML model processes this extracted event data to derive more comprehensive event context data. This may include determining the formality level of the event, a list of attendees, and a likely location, e.g., based on historical patterns or explicit mentions. Additionally, the ML model analyzes the user's selected outfit to extract item data and/or generate item context data, such as item type, usage history, and associations with similar past events.

The ML model detects an overlap between the event context data and item context data associated with at least one digital representation of an apparel item in the digital wardrobe database. In the example of FIG. 3, the overlap is related to the user's selected outfit for the upcoming party. The ML model identifies that the chosen outfit, or a similar outfit, was previously worn to an event attended by some of the same individuals who will be present at the upcoming party. Additionally, or alternatively, the ML model detects a relatively high similarity between the user's selected outfit and an outfit worn by another attendee, as observed in real-time event feeds or social media posts related to the event.

Upon detecting the overlap, the outfit detection module triggers the display of the notification 128 to alert the user. The notification 128 is displayed indicating an “Overlap Detected!” alert. The notification 128 indicates information about the detected overlap, such as text indicating that the user's selected outfit was previously worn to an event that John attended. The GUI 300 also presents, within the notification 128, an alternate outfit 302, shown as icons representing different clothing items including a patterned top, skirt, and shoes. The alternate outfit 302 is provided as a recommendation to avoid the indicated overlap.

The user interface 126 displays the notification 128 to the user as an integrated part of the messaging conversation. This on-demand presentation ensures that the alert is timely and contextually relevant, appearing shortly after the event is discussed in the conversation. Alternative display methods can include pop-up notifications, banner alerts, or in-app notifications. This presentation method allows the outfit detection module to provide alerts that are seamlessly integrated into the user's ongoing conversations and activities.

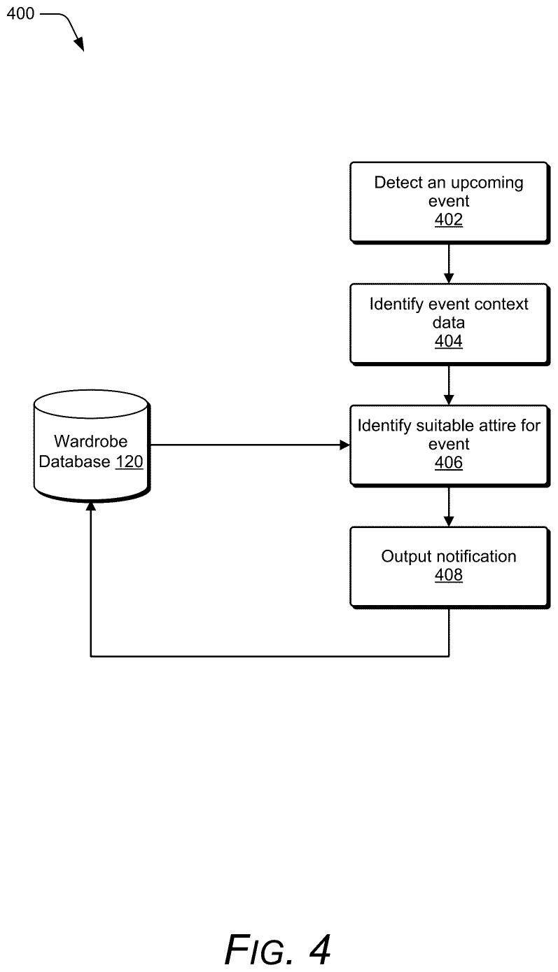

Example methods 400, 500, and 600 are described with reference to respective FIGS. 4, 5, and 6 in accordance with one or more implementations of context-aware apparel selection using ML models, as described herein. Generally, any services, components, modules, managers, controllers, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 4 illustrates an example method 400 for context-aware apparel selection using ML models in accordance with one or more implementations as described herein. The method 400 may implement aspects of the communication system 100. For example, the method 400 can be implemented by the outfit detection module 116 of the mobile device 102 to facilitate detection of overlaps between event context data and item context data associated with apparel items in the wardrobe database 120, as described with reference to FIG. 1. The order in which the method is described is not intended to be construed as a limitation, and any number or combination of the described operations can be performed in any order.

At 402, an event to be attended by a user of the mobile device 102 is detected. For example, the event detector 118 of the outfit detection module 116 may detect indicators of an event from a calendar application, a messaging application, or other device applications on the mobile device 102. In implementations, the outfit detection module 116 scans digital content of one or more device applications on the mobile device 102 and identifies (e.g., using an ML model, such as the ML model 124) one or more indicators of the event within the scanned digital content. In some implementations, the mobile device 102 receives a user input indicating the event. The outfit detection module 116 may extract event data identifying the event, such as event type, date, time, location, and potential attendees.

At 404, event context data associated with the event is identified. For instance, the outfit detection module 116 may utilize the ML model 124 to determine the event context data based on the extracted event data. The ML model 124 can classify the event data by associating it with event contexts. The event context data may include at least one of an event type, one or more attendees, a location, a formality level, an event duration, or an event start time. For example, the ML model 124 might recognize key words or phrases that indicate the formality level of the event, its purpose, or any particular requirements such as dress code.

At 406, the outfit detection module 116 analyzes the wardrobe database 120 to identify suitable attire for the event, e.g., based on a low likelihood of overlap. For example, the outfit detection module 116 may utilize the ML model 124 to analyze digital representations of apparel items belonging to the user and item context data associated with the digital representations of the apparel items. The outfit detection module 116 searches for overlaps between the event context data and the item context data. For instance, the ML model 124 can identify attendees of the event and search the wardrobe database 120 for digital representations of apparel items that have been worn in the presence of the same attendees. If the event is ongoing, the ML model 124 can analyze live feeds, social media posts, or other digital content related to the event to identify apparel items currently being worn by attendees and compare them with the user's wardrobe.

At 408, a notification is output based on an overlap between the event context data and item context data associated with at least one digital representation of an apparel item in the wardrobe database 120. For example, the outfit detection module 116 generates the notification 128 to alert the user via the user interface 126. The notification 128 may include or be an example of a pop-up alert, a banner, or an in-app message. The notification 128 indicates that an overlap is detected between item context data and event context data. The overlap may be, for example, between attendees of previous events to which the user has worn the apparel item and attendees of the upcoming event. Additionally, or alternatively, the overlap may be between attributes of the user's selected outfit or outfits in the user's wardrobe and attributes of an apparel item detected in a live feed of the event. In implementations, the notification 128 provides information about the detected event and the specific nature of the overlap, such as “You wore this outfit the last time you met with this client” or “Someone at the event is wearing a similar outfit based on the live feed.”

In some examples, the outfit detection module 116 may select alternative outfits from the wardrobe database 120 for display to the user via the notification 128, e.g., based on contextual information associated with the event, to minimize the risk of accidental overlap. The outfit detection module 116 selects alternative apparel items from the wardrobe database 120 that have no or few detected overlaps with the event context data. The notification 128 may display these alternatives as visual representations of the suggested apparel items, allowing the user to quickly identify suitable replacement options.

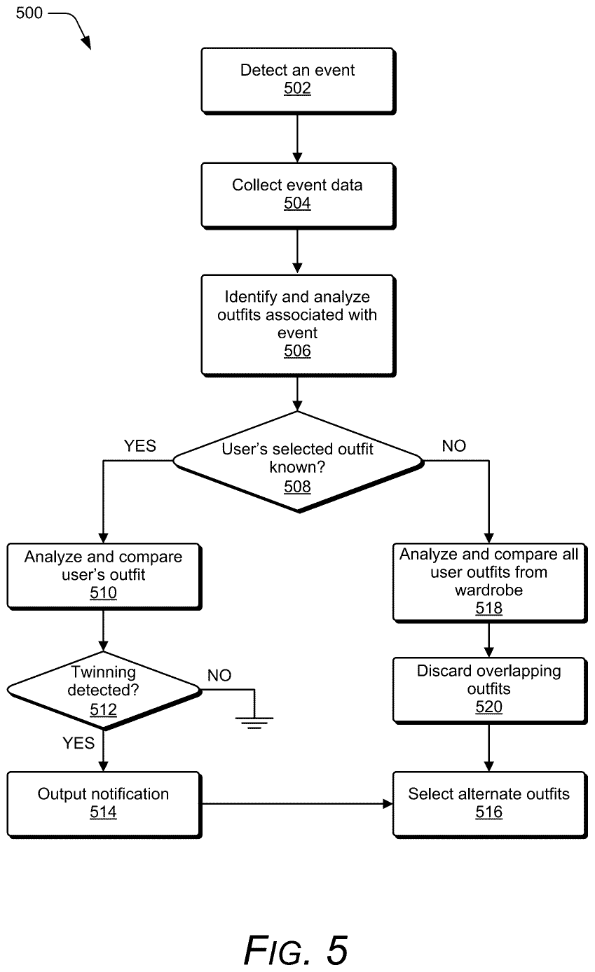

FIG. 5 illustrates example method(s) 500 for context-aware apparel selection using ML models. The order in which the method is described is not intended to be construed as a limitation, and any number or combination of the described method operations can be performed in any order to perform a method, or an alternate method.

At 502, an event is detected. For example, the outfit detection module 116 scans content of one or more device applications on the mobile device 102 and detects, using the ML model 124 and within the scanned content, one or more indicators of an event to be attended by a user of the mobile device 102.

At 504, event data is collected. For example, the outfit detection module 116 extracts event data based on the detecting. In some implementations, the outfit detection module 116 determines, using the ML model 124 and based on the event data, event context data associated with the event. The event context data may include at least one of an event type, one or more attendees, a location, a formality level, an event duration, or an event start time.

At 506, outfits associated with the event are identified and analyzed. For example, the outfit detection module 116 detects outfits appearing in digital content, such as photos and videos of the user attending previous events, live feeds of attendees at the event, and the like. The outfit detection module 116 utilizes the ML model 124 to analyze the detected outfits for attributes such as colors, styles, and patterns. For example, the outfit detection module 116 may analyze the content of a live camera feed to identify one or more apparel items appearing in the live camera feed and extract, using the ML model 124, at least one attribute associated with the one or more apparel items.

At 508, a determination is made whether the user's selected outfit is known. For example, the outfit detection module 116 may scan content of one or more device applications on the mobile device 102, such as a live feed from smart glasses being worn by the user or a picture of a selected outfit sent by the user in a messaging application. If the outfit detection module 116 can identify at least one apparel item as being selected by the user for the event based on the scanned content, the method 500 proceeds to 510.

At 510, the user's outfit is analyzed and compared. For example, the outfit detection module 116 may utilize the ML model 124 to analyze the user's outfit and determine attributes, such as color(s), style(s), and pattern(s). The ML model 124 then compares the attributes with the attributes of the outfits associated with the event, e.g., obtained at 506. That is, the ML model 124 compares item context data (e.g., user's outfit attributes) with event context data (e.g., attributes of outfits associated with the event).

At 512, a determination is made as to whether twinning (e.g., one or more matches between the attributes compared at 510) is detected. If twinning is detected, the method 500 proceeds to 514.

At 514, a notification is output. For example, the outfit detection module 116 outputs a notification (e.g., via a user interface of the mobile device 102) based on an overlap between the event context data and item context data associated with the user's outfit. The notification may indicate that the overlap is between attributes of the user's outfit and attributes of an outfit associated with the event, such as an outfit previously worn by the user to a similar event or an outfit currently being worn by another attendee at the event.

If, at 508, the user's selected outfit is not known, the method 500 proceeds to 518. At 518, all user outfits from the user's wardrobe are analyzed and compared. For example, the outfit detection module 116 analyzes, using the ML model 124, a digital wardrobe database of digital representations of apparel items belonging to the user and item context data associated with the digital representations of the apparel items. Each digital representation of an apparel item in the digital wardrobe database may be associated with respective item context data (e.g., item attributes, event context data associated with each prior event to which the user wore a corresponding apparel item). The outfit detection module 116 may utilize the ML model 124 to determine attributes of apparel items represented in the digital wardrobe database, such as color(s), style(s), and pattern(s). The ML model 124 then compares the attributes with the attributes of the outfits associated with the event, e.g., obtained at 506. That is, the ML model 124 compares item context data (e.g., user's outfit attributes) with event context data (e.g., attributes of outfits associated with the event).

At 520, overlapping outfits are discarded. For example, the outfit detection module 116 may identify overlaps between attributes of apparel items from the digital wardrobe database and attributes of the outfits associated with the event. Any apparel items from the digital wardrobe database having such attributes may be discarded from available apparel items to be selected by the user for the event.

At 516, alternate outfits are selected. For example, the outfit detection module 116 may identify apparel items from the digital wardrobe database that have little or no overlap with attributes of the outfits associated with the event. The outfit detection module 116 may output a notification (e.g., via a user interface of the mobile device 102) indicating the alternate outfits. For example, the notification may indicate a selected digital representation of an apparel item from the digital wardrobe database for the event based on a lack of overlap between item context data associated with the selected digital representation of the apparel item and the event context data.

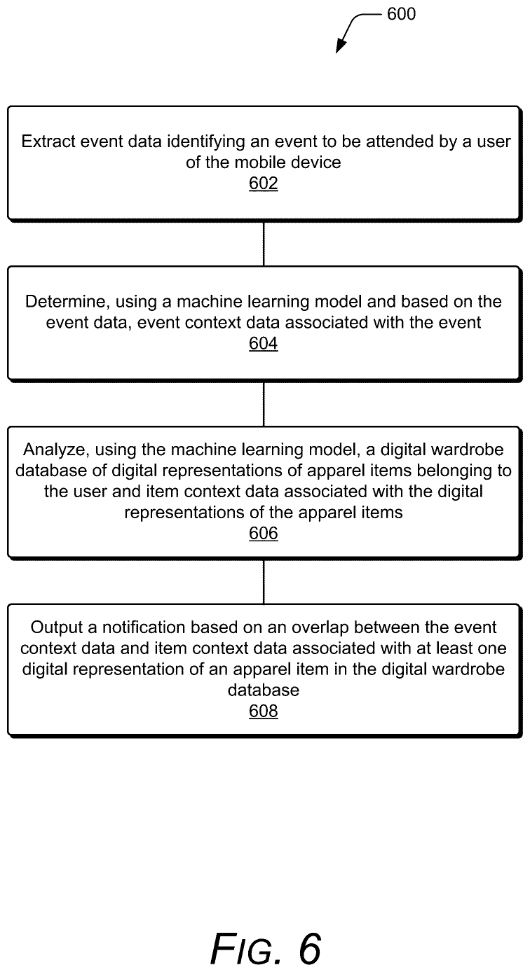

FIG. 6 illustrates an example method 600 for selecting digital content items using contextual data. The order in which the method is described is not intended to be construed as a limitation, and any number or combination of the described method operations can be performed in any order to perform a method, or an alternate method.

At 602, event data identifying an event to be attended by a user of the mobile device is extracted. For example, the outfit detection module 116 extracts event data from a calendar application, messaging application, or other device application(s) on the mobile device 102. In some implementations, to extract the event data, the outfit detection module 116 receives a user input indicating the event. Additionally, or alternatively, the outfit detection module 116 may scan content of one or more device applications on the mobile device and detect, using the ML model 124, one or more indicators of the event within the scanned content. In some cases, the content includes a live camera feed, and the outfit detection module 116 analyzes, using the ML model 124, the live camera feed to identify one or more apparel items appearing in the live camera feed. The outfit detection module 116 extracts, using the ML model 124, at least one attribute associated with the one or more apparel items, wherein the event context data includes the at least one attribute.

At 604, event context data associated with the event is determined using an ML model and based on the event data. For example, the outfit detection module 116 utilizes the ML model 124 to determine the event context data based on the extracted event data. The event context data may include at least one of an event type, one or more attendees, a location, a formality level, an event duration, or an event start time. To determine the event context data associated with the event, the outfit detection module 116 may classify the event data using the ML model trained to associate the event data with event contexts based on the one or more indicators.

At 606, a digital wardrobe database of digital representations of apparel items belonging to the user and item context data associated with the digital representations of the apparel items is analyzed using the ML model. For instance, the outfit detection module 116 may utilize the ML model 124 to analyze digital representations of apparel items in the wardrobe database 120. Each digital representation of an apparel item in the wardrobe database 120 may be associated with respective item context data, including one or more item attributes and respective event context data associated with each prior event to which the user wore a corresponding apparel item. In implementations, the outfit detection module 116 may scan content of one or more device applications on the mobile device 102 and detect, using the ML model 124, one or more indicators of the digital representations of the apparel items within the scanned content. To analyze the wardrobe database 120, the outfit detection module 116 may generate, using the ML model 124, one or more item attributes associated with the digital representations of apparel items based on the item context data, and identify the overlap based on a comparison between the one or more item attributes and the at least one attribute associated with the one or more apparel items.

In one or more implementations, the outfit detection module 116 automatically generates the wardrobe database 120 by extracting apparel data using the ML model 124 trained to identify the digital representations of the apparel items and the apparel data within the scanned content based on the one or more indicators. The outfit detection module 116 then generates, based on the apparel data, respective item context data for each of the digital representations of the apparel items, generates a respective database entry for each of the digital representations of the apparel items, and populates the respective database entry with the respective item context data.

In some implementations, the outfit detection module 116 automatically updates the wardrobe database 120 in response to receiving user input indicating a digital representation of an apparel item and one or more item attributes. The outfit detection module 116 then generates, using the ML model 124, corresponding item context data based on the one or more item attributes.

At 608, a notification is output based on an overlap between the event context data and item context data associated with at least one digital representation of an apparel item in the digital wardrobe database. For example, the outfit detection module 116 generates the notification 128 to alert the user via the user interface 126. The notification 128 may indicate that the overlap is between the one or more attendees of the event and at least one attendee of a prior event to which the user wore an apparel item. In some implementations, the outfit detection module 116 scans content of one or more device applications on the mobile device 102 and identifies the at least one digital representation of the apparel item as being selected by the user for the event based on the scanned content.

The notification 128 output by the outfit detection module 116 may indicate a selected digital representation of an apparel item from the wardrobe database 120 for the event based on a lack of overlap between item context data associated with the selected digital representation of the apparel item and the event context data.

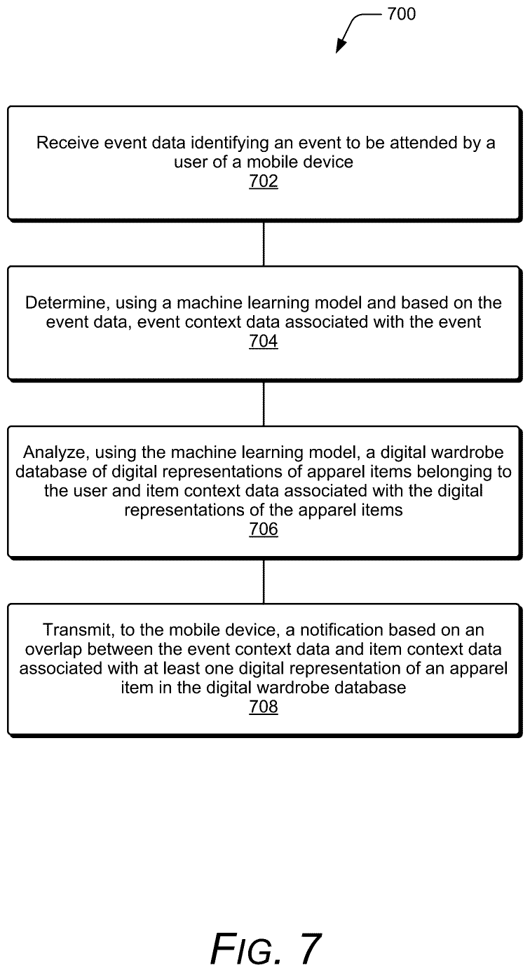

FIG. 7 illustrates one or more example methods 700 for context-aware apparel selection using ML models. The order in which the method is described is not intended to be construed as a limitation, and any number or combination of the described method operations can be performed in any order to perform a method, or an alternate method.

At 702, event data identifying an event to be attended by a user of a mobile device is received. For example, the server device 104 receives event data extracted from a calendar application, messaging application, or other device applications on the mobile device 102.

At 704, event context data associated with the event is determined using an ML model and based on the event data. For example, the server device 104 utilizes the ML model 140 to determine the event context data based on the extracted event data. The event context data may include at least one of an event type, one or more attendees, a location, a formality level, an event duration, or an event start time. In some implementations, to determine the event context data associated with the event, the event data is classified using the ML model 140 trained to associate the event data with event contexts based on one or more indicators detected within scanned content of device applications on the mobile device 102.

At 706, a digital wardrobe database of digital representations of apparel items belonging to the user and item context data associated with the digital representations of the apparel items is analyzed using the ML model. For instance, the server device 104 may utilize the ML model 140 to analyze digital representations of apparel items in the wardrobe database 136. Each digital representation of an apparel item in the wardrobe database 136 may be associated with respective item context data, including one or more item attributes and respective event context data associated with each prior event to which the user wore a corresponding apparel item.

At 708, a notification is transmitted to the mobile device based on an overlap between the event context data and item context data associated with at least one digital representation of an apparel item in the digital wardrobe database. For example, the server device 104 generates and transmits the notification 128 to alert the user via the user interface 126 of the mobile device 102. The notification 128 may indicate that the overlap is between the one or more attendees of the event and at least one attendee of a prior event to which the user wore an apparel item.

FIG. 8 illustrates various components of an example device 800, which can implement aspects of the techniques and features for context-aware apparel selection using ML models, as described herein. The example device 800 may be implemented as any of the devices described with reference to the previous FIGS. 1-7, such as any type of a wireless device, mobile device, mobile phone, flip phone, client device, companion device, display device, tablet, computing, communication, entertainment, gaming, media playback, and/or any other type of computing and/or electronic device. For example, the mobile device 102 or the server device 104 described with reference to FIGS. 1-7 may be implemented as the example device 800.

The example device 800 can include various, different communication devices 802 that enable wired and/or wireless communication of device data 804 with other devices. The device data 804 can include any of the various devices, data, and content that is generated, processed, determined, received, stored, and/or communicated from one computing device to another. Generally, the device data 804 can include any form of audio, video, image, graphics, and/or electronic data that is generated by applications executing on a device. The communication devices 802 can also include transceivers for cellular phone communication and/or for any type of network data communication.

The example device 800 can also include various, different types of data input/output (I/O) interfaces 806, such as data network interfaces that provide connection and/or communication links between the devices, data networks, and other devices. The data I/O interfaces 806 may be used to couple the device to any type of components, peripherals, and/or accessory devices, such as a computer input device that may be integrated with the example device 800. The I/O interfaces 806 may also include data input ports via which any type of data, information, media content, communications, messages, and/or inputs may be received, such as user inputs to the device, as well as any type of audio, video, image, graphics, and/or electronic data received from any content and/or data source.

The example device 800 includes a processor system 808 of one or more processors (e.g., any of microprocessors, controllers, and the like) and/or a processor and memory system implemented as a system-on-chip (SoC) that processes computer-executable instructions. The processor system 808 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device may be implemented with any one or combination of software, hardware, firmware, or fixed logic circuitry that may be implemented in connection with processing and control circuits, which are generally identified at 810. The example device 800 may also include any type of a system bus or other data and command transfer system that couples the various components within the device. A system bus can include any one or combination of different bus structures and architectures, as well as control and data lines.

The example device 800 also includes memory and/or memory devices 812 (e.g., computer-readable storage memory) that enable data storage, such as data storage devices implemented in hardware which may be accessed by a computing device, and that provide persistent storage of data and executable instructions (e.g., software applications, programs, functions, and the like). Examples of the memory devices 812 include volatile memory and non-volatile memory, fixed and removable media devices, and any suitable memory device or electronic data storage that maintains data for computing device access. The memory devices 812 can include various implementations of random access memory (RAM), read only memory (ROM), flash memory, and other types of storage media in various memory device configurations. The example device 800 may also include a mass storage media device.

The memory devices 812 (e.g., as computer-readable storage memory) provide data storage mechanisms, such as to store the device data 804, other types of information and/or electronic data, and various device applications 814 (e.g., software applications and/or modules). For example, an operating system 816 may be maintained as software instructions with a memory device 812 and executed by the processor system 808 as a software application. The device applications 814 may also include a device manager, such as any form of a control application, software application, signal processing and control module, code that is specific to a particular device, a hardware abstraction layer for a particular device, and so on.

In this example, the device 800 includes a context-aware selection module 818 that implements various aspects of the described features and techniques described herein. The context-aware selection module 818 may be implemented with hardware components and/or in software as one of the device applications 814, such as when the example device 800 is implemented as the mobile device 102 described with reference to FIGS. 1-6. An example of the context-aware selection module 818 is the outfit detection module 116 implemented by the mobile device 102, such as a software application and/or as hardware components in the mobile device. In implementations, the context-aware selection module 818 may include independent processing, memory, and logic components as a computing and/or electronic device integrated with the example device 800.

The example device 800 can also include a microphone 820 (e.g., to capture an audio recording of a user) and/or camera devices 822 (e.g., to capture video images of the user during a call), as well as device sensors 824, such as may be implemented as components of an inertial measurement unit (IMU). The device sensors 824 may be implemented with various sensors, such as a gyroscope, an accelerometer, and/or other types of motion sensors to sense motion of the device. The device sensors 824 can generate sensor data vectors having three-dimensional parameters (e.g., rotational vectors in x, y, and z-axis coordinates) indicating location, position, acceleration, rotational speed, and/or orientation of the device. The example device 800 can also include one or more power sources 826, such as when the device is implemented as a wireless device and/or a mobile device. The power sources may include a charging and/or power system, and may be implemented as a flexible strip battery, a rechargeable battery, a charged super capacitor, and/or any other type of active or passive power source.

The example device 800 can also include an audio and/or video processing system 828 that generates audio data for an audio system 830 and/or generates display data for a display system 832. The audio system and/or the display system may include any types of devices or modules that generate, process, display, and/or otherwise render audio, video, display, and/or image data. Display data and audio signals may be communicated to an audio component and/or to a display component via any type of audio and/or video connection or data link. In implementations, the audio system and/or the display system are integrated components of the example device 800. Alternatively, the audio system and/or the display system are external, peripheral components to the example device.

Although implementations for context-aware apparel selection using ML models have been described in language specific to features and/or methods, the appended claims are not necessarily limited to the specific features or methods described. Rather, the specific features and methods are disclosed as example implementations for context-aware apparel selection using ML models, and other equivalent features and methods are intended to be within the scope of the appended claims. Further, various different examples are described, and it is to be appreciated that each described example may be implemented independently or in connection with one or more other described examples. Additional aspects of the techniques, features, and/or methods discussed herein relate to one or more of the following:

A mobile device, comprising at least one memory; and at least one processor coupled with the at least one memory and operable to cause the mobile device to extract event data identifying an event to be attended by a user of the mobile device; determine, using an ML model and based on the event data, event context data associated with the event; analyze, using the ML model, a digital wardrobe database of digital representations of apparel items belonging to the user and item context data associated with the digital representations of the apparel items; and output a notification based on an overlap between the event context data and item context data associated with at least one digital representation of an apparel item in the digital wardrobe database.

A mobile device wherein the event context data includes at least one of an event type, one or more attendees, a location, a formality level, an event duration, or an event start time.

A mobile device wherein each digital representation of an apparel item in the digital wardrobe database is associated with respective item context data, and wherein the respective item context data includes one or more item attributes and respective event context data associated with each prior event to which the user wore a corresponding apparel item.

A mobile device wherein the notification indicates that the overlap is between the one or more attendees of the event and at least one attendee of a prior event to which the user wore an apparel item.

A mobile device wherein, to extract the event data, the at least one processor is further operable to cause the mobile device to receive a user input indicating the event.

A mobile device wherein, to extract the event data, the at least one processor is further operable to cause the mobile device to: scan content of one or more device applications on the mobile device; and detect, using the ML model, one or more indicators of the event within the scanned content.

A mobile device wherein, to determine the event context data associated with the event, the at least one processor is further operable to cause the mobile device to classify the event data using the ML model trained to associate the event data with event contexts based on the one or more indicators.

A mobile device wherein the content includes a live camera feed, and wherein the at least one processor is further operable to cause the mobile device to: analyze, using the ML model, the live camera feed to identify one or more apparel items appearing in the live camera feed; and extract, using the ML model, at least one attribute associated with the one or more apparel items, wherein the event context data includes the at least one attribute.

A mobile device wherein, to analyze the digital wardrobe database, the at least one processor is further operable to cause the mobile device to: generate, using the ML model, one or more item attributes associated with the digital representations of apparel items based on the item context data; and identify the overlap based on a comparison between the one or more item attributes and the at least one attribute associated with the one or more apparel items.

A mobile device wherein the at least one processor is further operable to cause the mobile device to: scan content of one or more device applications on the mobile device; and identify the at least one digital representation of the apparel item as being selected by the user for the event based on the scanned content.

A mobile device wherein the at least one processor is further operable to cause the mobile device to: scan content of one or more device applications on the mobile device; and detect, using the ML model, one or more indicators of the digital representations of the apparel items within the scanned content.

A mobile device wherein the at least one processor is further operable to cause the mobile device to automatically generate the digital wardrobe database by: extracting apparel data using the ML model trained to identify the digital representations of the apparel items and the apparel data within the scanned content based on the one or more indicators; generating, based on the apparel data, respective item context data for each of the digital representations of the apparel items; generating a respective database entry for each of the digital representations of the apparel items; and populating the respective database entry with the respective item context data.

A mobile device wherein the at least one processor is further operable to cause the mobile device to: automatically update the digital wardrobe database in response to receiving user input indicating a digital representation of an apparel item and one or more item attributes; and generate, using the ML model, corresponding item context data based on the one or more item attributes.

A mobile device wherein the notification indicates a selected digital representation of an apparel item from the digital wardrobe database for the event based on a lack of overlap between item context data associated with the selected digital representation of the apparel item and the event context data.

A system, comprising at least one memory; and at least one processor coupled with the at least one memory and operable to cause the system to receive event data identifying an event to be attended by a user of a mobile device; determine, using an ML model and based on the event data, event context data associated with the event; analyze, using the ML model, a digital wardrobe database of digital representations of apparel items belonging to the user and item context data associated with the digital representations of the apparel items; and transmit, to the mobile device, a notification based on an overlap between the event context data and item context data associated with at least one digital representation of an apparel item in the digital wardrobe database.

A system wherein the event context data includes at least one of an event type, one or more attendees, a location, a formality level, an event duration, or an event start time.

A system wherein each digital representation of an apparel item in the digital wardrobe database is associated with respective item context data, and wherein the respective item context data includes one or more item attributes and respective event context data associated with each prior event to which the user wore a corresponding apparel item.

A system wherein the notification indicates that the overlap is between the one or more attendees of the event and at least one attendee of a prior event to which the user wore an apparel item.

A system wherein, to determine the event context data associated with the event, the at least one processor is further operable to cause the system to classify the event data using the ML model trained to associate the event data with event contexts based on the one or more indicators.

A method performed by a mobile device, comprising extracting event data identifying an event to be attended by a user of the mobile device; determining, using an ML model and based on the event data, event context data associated with the event; analyzing, using the ML model, a digital wardrobe database of digital representations of apparel items belonging to the user and item context data associated with the digital representations of the apparel items; and outputting a notification based on an overlap between the event context data and item context data associated with at least one digital representation of an apparel item in the digital wardrobe database.

What is claimed is:

1. A mobile device, comprising:
at least one memory; and
at least one processor coupled with the at least one memory and operable to cause the mobile device to:
extract event data identifying an event to be attended by a user of the mobile device;
determine, using a machine learning model and based on the event data, event context data associated with the event;
analyze, using the machine learning model, a digital wardrobe database of digital representations of apparel items belonging to the user and item context data associated with the digital representations of the apparel items; and
output a notification based on an overlap between the event context data and item context data associated with at least one digital representation of an apparel item in the digital wardrobe database.

2. The mobile device of claim 1, wherein the event context data includes at least one of an event type, one or more attendees, a location, a formality level, an event duration, or an event start time.

3. The mobile device of claim 2, wherein each digital representation of an apparel item in the digital wardrobe database is associated with respective item context data, and wherein the respective item context data includes one or more item attributes and respective event context data associated with each prior event to which the user wore a corresponding apparel item.

4. The mobile device of claim 3, wherein the notification indicates that the overlap is between the one or more attendees of the event and at least one attendee of a prior event to which the user wore an apparel item.

5. The mobile device of claim 1, wherein, to extract the event data, the at least one processor is further operable to cause the mobile device to receive a user input indicating the event.

6. The mobile device of claim 1, wherein, to extract the event data, the at least one processor is further operable to cause the mobile device to:
scan content of one or more device applications on the mobile device; and
detect, using the machine learning model, one or more indicators of the event within the scanned content.

7. The mobile device of claim 6, wherein, to determine the event context data associated with the event, the at least one processor is further operable to cause the mobile device to classify the event data using the machine learning model trained to associate the event data with event contexts based on the one or more indicators.

8. The mobile device of claim 7, wherein the content includes a live camera feed, and wherein the at least one processor is further operable to cause the mobile device to:
analyze, using the machine learning model, the live camera feed to identify one or more apparel items appearing in the live camera feed; and
extract, using the machine learning model, at least one attribute associated with the one or more apparel items, wherein the event context data includes the at least one attribute.

9. The mobile device of claim 8, wherein, to analyze the digital wardrobe database, the at least one processor is further operable to cause the mobile device to:
generate, using the machine learning model, one or more item attributes associated with the digital representations of apparel items based on the item context data; and
identify the overlap based on a comparison between the one or more item attributes and the at least one attribute associated with the one or more apparel items.

10. The mobile device of claim 1, wherein the at least one processor is further operable to cause the mobile device to:
scan content of one or more device applications on the mobile device; and
identify the at least one digital representation of the apparel item as being selected by the user for the event based on the scanned content.

11. The mobile device of claim 1, wherein the at least one processor is further operable to cause the mobile device to:
scan content of one or more device applications on the mobile device; and
detect, using the machine learning model, one or more indicators of the digital representations of the apparel items within the scanned content.

12. The mobile device of claim 11, wherein the at least one processor is further operable to cause the mobile device to automatically generate the digital wardrobe database by:
extracting apparel data using the machine learning model trained to identify the digital representations of the apparel items and the apparel data within the scanned content based on the one or more indicators;
generating, based on the apparel data, respective item context data for each of the digital representations of the apparel items;
generating a respective database entry for each of the digital representations of the apparel items; and
populating the respective database entry with the respective item context data.

13. The mobile device of claim 1, wherein the at least one processor is further operable to cause the mobile device to:
automatically update the digital wardrobe database in response to receiving user input indicating a digital representation of an apparel item and one or more item attributes; and
generate, using the machine learning model, corresponding item context data based on the one or more item attributes.

14. The mobile device of claim 1, wherein the notification indicates a selected digital representation of an apparel item from the digital wardrobe database for the event based on a lack of overlap between item context data associated with the selected digital representation of the apparel item and the event context data.

15. A system, comprising:
at least one memory; and
at least one processor coupled with the at least one memory and operable to cause the system to:
receive event data identifying an event to be attended by a user of a mobile device;
determine, using a machine learning model and based on the event data, event context data associated with the event;
analyze, using the machine learning model, a digital wardrobe database of digital representations of apparel items belonging to the user and item context data associated with the digital representations of the apparel items; and
transmit, to the mobile device, a notification based on an overlap between the event context data and item context data associated with at least one digital representation of an apparel item in the digital wardrobe database.

16. The system of claim 15, wherein the event context data includes at least one of an event type, one or more attendees, a location, a formality level, an event duration, or an event start time.

17. The system of claim 16, wherein each digital representation of an apparel item in the digital wardrobe database is associated with respective item context data, and wherein the respective item context data includes one or more item attributes and respective event context data associated with each prior event to which the user wore a corresponding apparel item.

18. The system of claim 17, wherein the notification indicates that the overlap is between the one or more attendees of the event and at least one attendee of a prior event to which the user wore an apparel item.

19. The system of claim 15, wherein, to determine the event context data associated with the event, the at least one processor is further operable to cause the system to classify the event data using the machine learning model trained to associate the event data with event contexts.

20. A method performed by a mobile device, comprising:
extracting event data identifying an event to be attended by a user of the mobile device;
determining, using a machine learning model and based on the event data, event context data associated with the event;
analyzing, using the machine learning model, a digital wardrobe database of digital representations of apparel items belonging to the user and item context data associated with the digital representations of the apparel items; and
outputting a notification based on an overlap between the event context data and item context data associated with at least one digital representation of an apparel item in the digital wardrobe database.
